(19) United States
(12) Patent Application Publication
(10) Pub. No.: US 2018/0300851 A1
(43) Pub. Date: Oct. 18, 2018

(54) GENERATING A REACTIVE PROFILE PORTRAIT

(71) Applicant: Facebook, Inc., Menlo Park, CA (US)

(72) Inventors: Hadar Elor, Seattle, WA (US); Michael F. Cohen, Seattle, WA (US); Johannes Peter Kopf, Seattle, WA (US)

(21) Appl. No.: 15/953,174

(22) Filed: Apr. 13, 2018

Related U.S. Application Data
(60) Provisional application No. 62/485,871, filed on Apr. 14, 2017.

(51) Int. Cl. G06T 3/00; G06K 9/00

(52) U.S. Cl. CPC G06T 3/0093; H04L 51/32; G06K 9/00315

(57) ABSTRACT

A reactive profile picture brings a profile image to life by displaying short video segments of the target user expressing a relevant emotion in reaction to an action by a viewing user that relates to content associated with the target user in an online system such as a social media web site. The viewing user therefore experiences a real-time reaction in a manner similar to a face-to-face interaction. The reactive profile picture can be automatically generated from either a video input of the target user or from a single input image of the target user.

### CROSS-REFERENCE TO RELATED APPLICATION

This application claims the benefit of U.S. Provisional Patent Application No. 62/485,871 filed on Apr. 14, 2017, which is incorporated by reference herein.

### BACKGROUND

This disclosure relates to generating reactive profile pictures in an online system.

In social media web sites and other online systems, users can provide content to the online system that can be viewed and interacted with by other users. For example, users can comment on another user's profile page, comment on a post from another user, or express a sentiment relating to content provided by another user. When interacting in a virtual environment, the interactions lack the sense of connection that can be achieved in face-to-face interactions because there is no real-time expressive feedback in the form of facial expression or body language that occurs in real world.

### SUMMARY

A method generates a reactive profile portrait in response to an action. A plurality of video segments depicting a portrait of a target user is stored in association with a profile of a target user. Each of the plurality of video segments is associated with a different emotion and depicts the target user expressing the corresponding emotion. The plurality of video segments includes an idle segment depicting the target user in a neutral expression. A client device of a viewing user is provided with a presentation of the idle segment together with content associated with the target user. An interaction of the viewing user on the client device with the content associated with the target user is detected. The interaction is analyzed to determine a sentiment associated with the interaction. Based on the sentiment, a reactive video segment is selected from the plurality of video segments. The reactive video segment associated with an emotion corresponding to the sentiment of the interaction. The reactive video segment is presented to the client device.

In an embodiment, a sequence of starting overlapping frames associated with the reactive video segment is blended with a sequence of ending overlapping frames associated with the idle segment to generate a sequence of transition frames. The transition frames are presented to transition from the idle segment to the reactive video segment. In an embodiment, in order to perform the blending, a sequence of transformations may be determined to warp the sequence of ending overlapping frames to align locations of facial landmarks in the sequence of ending overlapping frames to locations of facial landmarks in the sequence of starting overlapping frames. The sequence of transformations are weighted with increasing weights over a duration of the sequence of ending overlapping frames and the sequence of starting overlapping frames to generate a weighted sequence of transformations. The weighted sequence of transformations are then applied to the ending overlapping frames to generate the sequence of transition frames.

In an embodiment, a starting set of overlapping frames associated with the idle segment are blended with a set of ending overlapping frames associated with the reactive video segment to generate a set of ending transition frames. The ending transition frames are presented to transition from the reactive video segment back to the idle video segment.

In an embodiment, a selection of an emoticon by the viewing user associated with the content associated with the target user is detected and a predefined association between the emoticon and the sentiment is identified.

In an embodiment, a written post by the viewing user associated with the content associated with the target user is detected and a sentiment analysis of text of the written post is performed. The sentiment is determined from the sentiment analysis.

In an embodiment, the interaction comprises capturing a video of the viewing user while viewing the content associated with the target user. A facial analysis is performed to detect an expression of the viewing user. The sentiment is determined from the detected expression.

In another embodiment, a non-transitory computer-readable storage medium stores instructions executable by a processor that when executed cause the processor to perform any of the methods described above.

In another embodiment, a computer system includes a processor and a non-transitory computer-readable storage medium that stores instructions executable by that processor that when executed cause the processor to perform any of the methods described above.

### BRIEF DESCRIPTION OF THE DRAWINGS

FIG. 1 is block diagram illustrating an embodiment of a system environment for an online system.

FIG. 2 is block diagram illustrating an embodiment of an online system.

FIG. 3 is block diagram illustrating an embodiment of a reactive profile picture generator.

FIG. 4 is a flowchart illustrating an embodiment of a process for segmenting a video into emotion segments based on detecting peak expression frames.

FIG. 5 is a flowchart illustrating an embodiment of a process for generating a reactive profile in response to an action.

FIG. 6 is a block diagram illustrating an embodiment of a segment acquisition module.

FIG. 7 is a flowchart illustrating an embodiment of a process for generating video segments of a portrait depicting different emotions from an input image.

FIG. 8 is an example embodiment of facial landmarks on an example image of a face.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### Overview

A reactive profile picture brings a profile image to life by displaying short video segments of the target user expressing a relevant emotion in reaction to an action by a viewing user that relates to content associated with the target user in an online system such as a social media web site. The viewing user therefore experiences a real-time reaction in a manner similar to a face-to-face interaction. The reactive profile picture can be automatically generated from either a video input of the target user or from a single input image of the target user.

### System Architecture

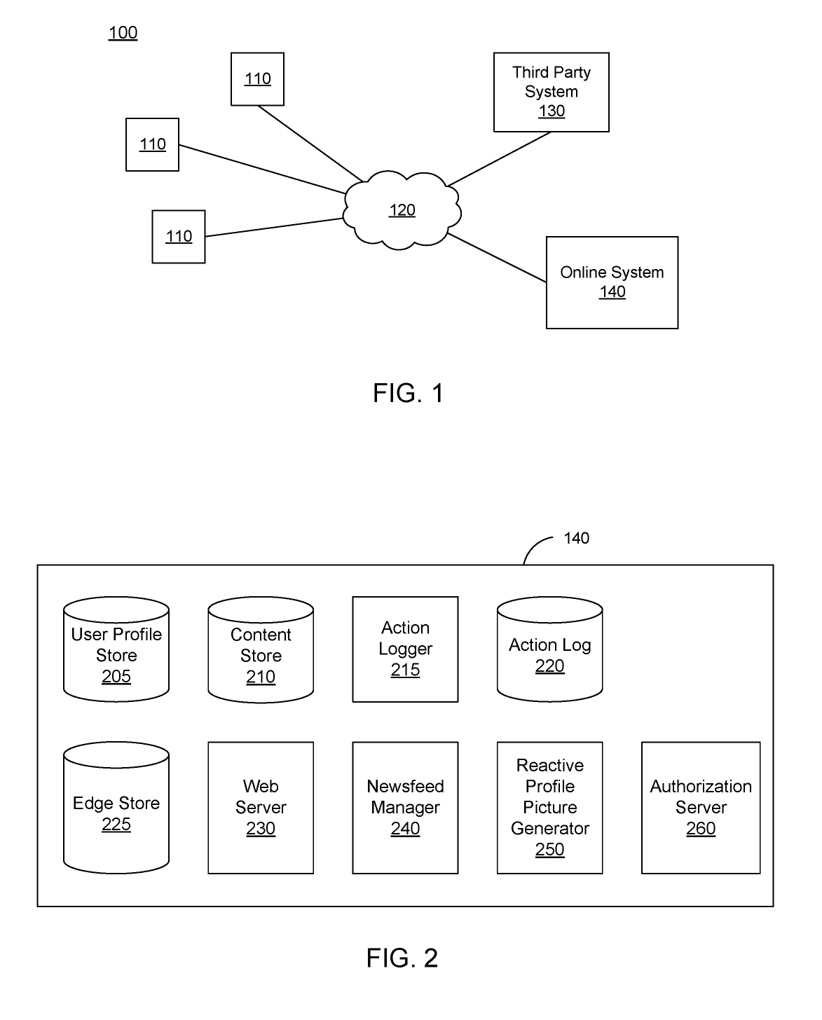

FIG. 1 is a block diagram of a system environment 100 for an online system 140. The system environment 100 shown in FIG. 1 comprises one or more client devices 110, a network 120, one or more third-party systems 130, and the online system 140. The online system 140 may be, for example, a social networking system, a content sharing network, or another system providing content to users. In alternative configurations, different and/or additional components may be included in the system environment 100.

The client devices 110 are computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider server or set of servers communicating information describing applications for execution by a client device 110 or communicating data to client devices 110 for use by an application executing on the client device 110. In other embodiments, a third party system 130 provides content or other information for presentation via a client device 110. A third party system 130 may also communicate information to the online system 140, such as advertisements, content, or information about an application provided by the third party system 130.

FIG. 2 is a block diagram of an architecture of the online system 140. The online system 140 shown in FIG. 2 includes a user profile store 205, a content store 210, an action logger 215, an action log 220, an edge store 225, a web server 230, a newsfeed manager 240, and a reactive profile picture generator 250. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image, with information identifying the images in which a user is tagged stored in the user profile of the user. A user profile in the user profile store 205 may also maintain references to actions by the corresponding user performed on content items in the content store 210 and stored in the action log 220.

The user profile also includes a primary profile image, typically a portrait of the user, that may be used throughout the online system 140 to enable other users to identify the user. For example, the primary profile image may be displayed at a prominent location on the user's profile page and may also be displayed together with posts made by the user in the online system 140. The primary profile image may also be displayed together with messages received from the user, to identify the user when the user appears in a list of another user's connections, or anywhere else in the online system 140 where it is desirable to identify the user.

While user profiles in the user profile store 205 are frequently associated with individuals, user profiles may also be stored as a brand page for entities such as businesses or organizations. This allows an entity to establish a presence on the online system 140 for connecting and exchanging content with other online system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140. In one embodiment, content objects posted by a particular user may be displayed together with a profile picture for the user in order to identify the user that provided, or is associated with, the content.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a client device 110, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, and engaging in a transaction. Interactions may also include selecting an emoticon associated with a particular emotion or reaction to an object posted by another user. For example, emoticons may include a “like” emoticon, a “love” emoticon, a “laughter” emoticon, a “surprise” emoticon, a “sad” emoticon, an “angry” emoticon, or other emoticons associated with different emotions or reactions that a user may want to express in response to an object from another user.

Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce websites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying. Additionally, actions a user performs via an application associated with a third party system 130 and executing on a client device 110 may be communicated to the action logger 215 by the application for recordation and association with the user in the action log 220.

In one embodiment, the edge store 225 stores information describing connections between users and other objects on the online system 140 as edges. For example, the edges between users may represent connections in a social graph. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

An edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or user. For example, a feature may represent the level of interest that a user has in a particular topic, the rate at which the user logs into the online system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate the user's interest in an object, in a topic, or in another user in the online system 140 based on actions performed by the user. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

In one embodiment, the online system 140 identifies stories likely to be of interest to a user through a “newsfeed” presented to the user. A story presented to a user describes an action taken by an additional user connected to the user and identifies the additional user. In some embodiments, a story describing an action performed by a user may be accessible to users not connected to the user that performed the action. The newsfeed manager 240 may generate stories for presentation to a user based on information in the action log 220 and in the edge store 225 or may select candidate stories included in the content store 210. One or more of the candidate stories are selected and presented to a user by the newsfeed manager 240.

For example, the newsfeed manager 240 receives a request to present one or more stories to an online system user. The newsfeed manager 240 accesses one or more of the user profile store 205, the content store 210, the action log 220, and the edge store 225 to retrieve information about the identified user. For example, stories or other data associated with users connected to the identified user are retrieved. The retrieved stories or other data are analyzed by the newsfeed manager 240 to identify candidate content items, which include content having at least a threshold likelihood of being relevant to the user. For example, stories associated with users not connected to the identified user or stories associated with users for which the identified user has less than a threshold affinity are discarded as candidate stories. Based on various criteria, the newsfeed manager 240 selects one or more of the candidate stories for presentation to the identified user.

In various embodiments, the newsfeed manager 240 presents stories to a user through a newsfeed including a plurality of stories selected for presentation to the user. The newsfeed may include a limited number of stories or may include a complete set of candidate stories. The number of stories included in a newsfeed may be determined in part by a user preference included in user profile store 205. The newsfeed manager 240 may also determine the order in which selected stories are presented via the newsfeed. For example, the newsfeed manager 240 determines that a user has a highest affinity for a specific user and increases the number of stories in the newsfeed associated with the specific user or modifies the positions in the newsfeed where stories associated with the specific user are presented.

The newsfeed manager 240 may also account for actions by a user indicating a preference for types of stories and selects stories having the same, or similar, types for inclusion in the newsfeed. Additionally, the newsfeed manager 240 may analyze stories received by the online system 140 from various users to obtain information about user preferences or actions from the analyzed stories. This information may be used to refine subsequent selection of stories for newsfeeds presented to various users.

The web server 230 links the online system 140 via the network 120 to the one or more client devices 110, as well as to the one or more third party systems 130. The web server 230 serves web pages, as well as other content, such as JAVA®, FLASH®, XML and so forth. The web server 230 may receive and route messages between the online system 140 and the client device 110, for example, instant messages, queued messages (e.g., email), text messages, short message service (SMS) messages, or messages sent using any other suitable messaging technique. A user may send a request to the web server 230 to upload information (e.g., images or videos) that are stored in the content store 210. Additionally, the web server 230 may provide application programming interface (API) functionality to send data directly to native client device operating systems, such as IOS®, ANDROID™, or BlackberryOS.

The authorization server 260 enforces one or more privacy settings of the users of the online system 140. A privacy setting of a user determines how particular information associated with a user can be shared, and may be stored in the user profile of a user in the user profile store 205 or stored in the authorization server 260 and associated with a user profile. In one embodiment, a privacy setting specifies particular information associated with a user and identifies the entity or entities with whom the specified information may be shared. Examples of entities with which information can be shared may include other users, applications, third party systems 130 or any entity that can potentially access the information. Examples of information that can be shared by a user include user profile information like profile photo including the reactive profile picture described below, phone numbers associated with the user, user's connections, actions taken by the user such as adding a connection, changing user profile information and the like.

The privacy setting specification may be provided at different levels of granularity. In one embodiment, a privacy setting may identify specific information to be shared with other users. For example, the privacy setting identifies a work phone number or a specific set of related information, such as, personal information including profile photo, home phone number, and status. Alternatively, the privacy setting may apply to all the information associated with the user. Specification of the set of entities that can access particular information may also be specified at various levels of granularity. Various sets of entities with which information can be shared may include, for example, all users connected to the user, a set of users connected to the user, additional users connected to users connected to the user all applications, all third party systems 130, specific third party systems 130, or all external systems.

One embodiment uses an enumeration of entities to specify the entities allowed to access identified information or to identify types of information presented to different entities. For example, the user may specify types of actions that are communicated to other users or communicated to a specified group of users. Alternatively, the user may specify types of actions or other information that is not published or presented to other users.

The authorization server 260 includes logic to determine if certain information associated with a user can be accessed by a user's friends, third-party system 130 and/or other applications and entities. For example, a third-party system 130 that attempts to access a user's comment about a uniform resource locator (URL) associated with the third-party system 130 must get authorization from the authorization server 260 to access information associated with the user. Based on the user's privacy settings, the authorization server 260 determines if another user, a third-party system 130, an application or another entity is allowed to access information associated with the user, including information about actions taken by the user. For example, the authorization server 260 uses a user's privacy setting to determine if the user's comment about a URL associated with the third-party system 130 can be presented to the third-party system 130 or can be presented to another user. Similarly, the authorization server 260 can determine what viewing user's or third party systems 130 may have access to a target user's reactive profile picture. This enables a user's privacy setting to specify which other users, or other entities, are allowed to receive data about the user's actions or other data associated with the user.

The reactive profile picture generator 250 generates reactive profile pictures that may selectively be displayed in place of the primary profile image described above. The use of a reactive profile picture and the associated features described herein may be made available as an optional feature such that a user may opt into using a reactive profile picture. Furthermore, various levels of options may be made available such that the user may opt in to use the reactive profile in certain situations or enable it to be viewed by certain viewers without necessarily opting in to all available uses of the reactive profile picture.

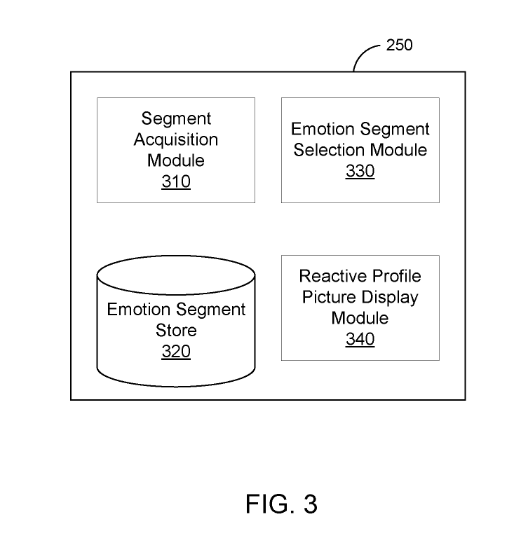

For example, the reactive profile picture may be displayed on a user's profile page or may be displayed together with content posted by the user to the online system 140. The reactive profile picture generator 250 may store, for each user, a plurality of short video segments of the user's portrait each expressing different reactions or emotions. For example, segments may depict the user expressing reactions or emotions such as liking, disliking, loving, laughing, or feeling shock, sadness, happiness, anger, surprise, approval, disapproval, or other emotions. The video segments may also include a segment of the user in a neutral expression. Where reactive profile pictures are used, the reactive profile picture generator 250 may selectively display a relevant segment for a target user in real-time in response to different actions or other trigger events occurring in the online system 140. For example, a profile picture of a target user may be displayed together with a post made by the target user in the online system 140. When a viewing user views the post, the viewing user may initially be presented with the reactive profile picture of the target user as looped video segment or still image of the target user in a neutral expression. When the viewing user selects an emoticon to “like” the post, the reactive profile picture generator 250 updates the reactive profile picture in real-time (as seen by the viewing user) to show a video segment of the target user expressing happiness or approval in reaction to the viewing user liking the post. The reactive profile picture generator 250 may then return the reactive profile picture (as seen by the viewing user) to the still image or the looped segment of the target user in the neutral expression. If the viewing user instead selects an “angry” emoticon in reaction to the post, the reactive profile picture generator 250 may instead update the reactive profile picture of the target user in real-time (as seen by the viewing user) to show a video segment of the target user expressing anger in reaction to the viewing user's action. Thus, the reactive profile picture makes the target user's profile image come alive when a viewing user interacts with content objects associated with the target user, thus providing more a lifelike interaction experience for the viewing user. An example embodiment of a reactive profile picture generator 250 is described in further detail in FIG. 3.

FIG. 3 illustrates an example of a reactive profile picture generator 250. The reactive profile picture generator 250 comprises a segment acquisition module 310, a reactive segment store 320, a segment selection module 330, and a reactive profile picture display module 340. Alternative embodiments, may include additional or different modules to implement the functions associated with the reactive profile picture generator 250 described herein.

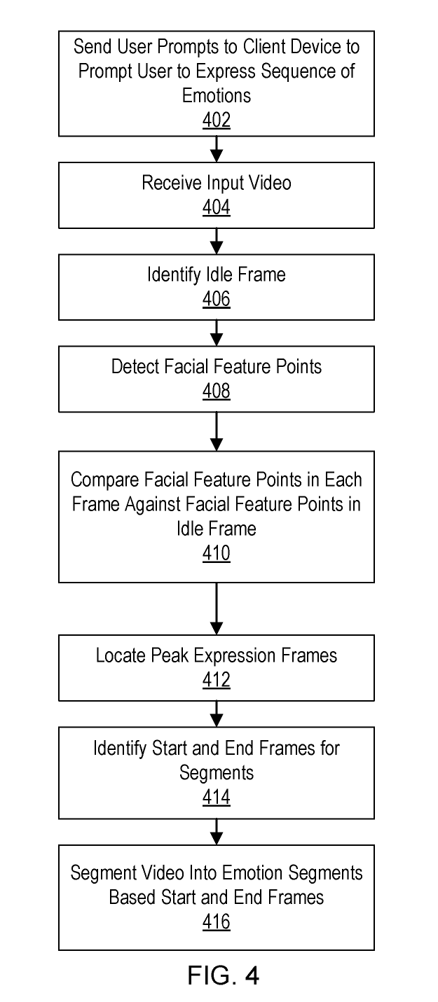

The segment acquisition module 310 acquires a plurality of video segments for a user, each associated with a different reaction or emotion. Each of the video segments may depict a portrait of the user making different facial expressions indicative of the reaction or emotion. In one embodiment, the segment acquisition module 310 provides a user interface that provides a sequence of prompts to the user to make the different facial expressions while a video recording device (e.g., a camera) records a video of the user's portrait. For example, the prompts may instruct the user to “act happy,” “laugh,” “act angry,” “act sad,” etc. at different time points in order to capture video of the different expressions. The segment acquisition module 310 may then process the captured video to segment the video into individual emotion segments and store them to the emotion segment store 320. For example, each segment may be stored in association with an identifier of the user and one or more metadata tags indicating the emotion associated with the segment. In another embodiment, the segment acquisition module 310 receives the input video directly from a user, without necessarily providing any prompts to the user while the video is being captured. An embodiment of a process for segmenting the video into segments is described in further detail below with respect to FIG. 4.

The emotion segment selection module 330 selects an appropriate video segment for displaying in a user's reactive profile picture in response to a particular action. For example, a predefined emotion segment may be displayed in response to another user selecting a particular emoticon as a reaction to a post from the user. In another example, the emotion segment selection module 330 may apply natural language processing to perform a sentiment analysis of a comment or reply to a post from the user and select (for displaying to the user making the comment or reply) a video segment related to the determined sentiment. In yet another example, the emotion segment selection module 330 may monitor (e.g., via video camera on the user's device) a user viewing a profile page, posts, or other objects associated with a user having a reactive profile picture and analyze the video to detect expressions by the viewing user associated with particular emotions. The video segment selection module 330 then selects a video segment to display to the viewing user in the reactive profile picture that matches the detected emotion of the viewing user. In yet another example, audio captured by a microphone on a viewing user's device may be analyzed to determine an emotion expressed by the viewing user when viewing a profile page, post or other object associated with a user having a reactive profile picture. The video segment selection module 330 may then select a video segment matching the detected emotion of the viewing user.

In yet another embodiment, the video segment selection module 330 may select a video segment to display to a viewing user in response to the viewing user performing a particular gesture or interaction with the online system 140. For example, in one embodiment, the video segment selection module 330 automatically selects a predefined baseline video segment (which may be different than the idle segment) for displaying to a viewing user when the viewing user scrolls to a content object associated with the target user in the viewing user's newsfeed. In another example, the video segment selection module 330 automatically selects a predefined video segment when the viewing user turns his/her head when viewing content in the online system 140 using a virtual reality headset, such that content associated with the target user comes into view.

In yet another example, the video segment selection module 330 may select a video segment to display in response to a viewing user capturing an image on camera (e.g. a selfie image) of the client device 110 used by the viewing user while viewing content associated with a target user. The expression of the viewing user may be analyzed and an appropriate video segment reacting to the viewing user may be selected.

In other additional embodiments, the segment selection module 330 may select segments differently for different viewing users based on edges connected to the viewing user in a social graph or affinities between the viewing user and other objects or users. Furthermore, segments may be selected differently depending on the edges connected to the target user, the particular content object that the reactive profile picture is displayed with, or affinities with other objects or users. For example, a viewing user that has a “best friend” connection with the target user or has a high affinity connection may see a “happy” segment of the target user as a default instead of a neutral expression segment. In other embodiments, a segment may be selected based on the viewing user's affinity to related content objects even if the viewing user has not directly expressed any sentiment specifically relating to the content object presently being viewed.

In embodiments in which video, audio, or other content associated with the viewing user is captured to trigger a change in the reactive profile picture of a target user, the viewing user is provided an option to opt in to this feature such that audio or video is not captured without the viewing user's knowledge and consent, nor is the audio or video analyzed in the manner described without the viewing user's knowledge and consent.

The reactive profile picture display module 340 renders the selected video segment for display in a reactive profile picture. The reactive profile picture display module 340 may perform various video processing operations on the selected segment to cause the video segments to be displayed in a manner that smoothly transition between segments. For example, in one embodiment, an idle segment of the user in a neutral expression may loop until an action is received that causes the emotion segment selection module 330 to select a different emotion segment for display. The reactive profile picture display module 340 then smoothly transitions from the idle segment to the selected emotion segment and upon completion, smoothly transitions back to the idle segment. The transitions between segments may be displayed in a manner that gives the appearance of a continuous video stream without obvious cuts between segments, as will be described in further detail below.

### Video Segment Acquisition for Reactive Profile Pictures

FIG. 4 illustrates an embodiment of a video segment acquisition process for acquiring the various emotion segments used for a reactive profile picture. The segment acquisition module 310 sends 402 prompts to a client device 110 to prompt a user to perform a sequence of particular facial expressions associated with different emotions while the client device 110 captures a video of the user's portrait. In an embodiment, the prompts may occur at predefined timing and may occur according to a predefined sequence such that the order and timing of the expressions expected to be received is known. Alternatively, the user may be prompted prior to recording to portray different expressions in a particular order, without necessarily being prompted according to any particular timing. The segment acquisition module 310 then receives 404 the recorded input video that includes the sequence of facial expressions.

In an alternative embodiment, step 402 may be omitted and a script prompting the user for facial expressions may instead execute directly on the client device 110 or the user may simply be provided with a set of written instructions. In this embodiment, the user then uploads the video and it is received 404 by the online system 140.

The segment acquisition module 310 then identifies 406 an idle frame in the video. The idle frame represents a frame depicting the user with a neutral expression that will be used as a baseline profile picture in the steps that follow. In one embodiment, the idle frame may be extracted from a segment of the video during which the user was prompted to provide a neutral expression (i.e., an idle segment). For example, the segment acquisition module 310 may determine (e.g., from a lookup table), a time range or frame range in the video where the neutral expression is expected to occur. From within this idle segment, the idle frame is selected a frame that best meets a set of predefined criteria. For example, criteria for selecting the idle frame may be based on, for example, a detected orientation of the face or locations of certain feature points on the face that make a frame most suitable for use as the idle frame such as, for example, a frame where the face is looking straight ahead and has less than a threshold level of motion. In another embodiment, the idle frame may be synthesized based on a combination of frames in the idle segment, such as, for example, by averaging a plurality of frames.

Facial landmarks are then detected 408 in each of the frames of video. The landmarks represent anatomical points on a human face that can be automatically detected in a consistent way between multiple varied subjects under different lighting conditions, orientations, etc. For example, the facial landmarks may indicate locations of certain prominent points of the lips, eyes, nose, eyebrows, chin, forehead, ears or other facial features. An example of facial landmarks is illustrated in FIG. 8 in which each of the landmarks (represented by the dots) corresponds to a particular anatomical feature. Particular locations of the landmarks within an image may vary depending on the subject's facial expressions.

Returning to FIG. 4, the segment acquisition module 310 then compares 410 the locations of the facial landmarks in each frame of the acquired video against the locations of corresponding facial landmarks (i.e., corresponding to the same facial features) in the idle frame. For example, a distance metric (e.g., an L2-norm distance) between the set of landmarks in a given frame to the respective corresponding landmarks in the idle frame may be computed.

The segment acquisition module 310 locates 412 a plurality of peak expression frame corresponding to local maxima in the computed distance metric. In one embodiment where the different expressions occur during known time periods in the input video, the peak expression frames may be constrained such that one peak expression frame from each time period is selected. For example, a lookup table may specify which emotion is expected to correspond to each time period. Alternatively, the peak expression frames may be selected by finding local maxima without necessarily constraining their locations to particular time periods. The peak expressions frames correspond to frames in which the facial landmarks have, on average, the greatest distance from their respective locations the idle frame. In this embodiment, each peak expression frame may be assigned to a particular emotion according to a predefined sequence. Alternatively, emotions may be automatically determined based on a facial analysis.

For each detected peak expression frame, start and end frames of an emotion segment around the peak expression frame are then identified 414. In one embodiment, the start and end frames are selected are from a constrained range of frames before and after the peak expression respectively so that a length of the emotion segment falls within a predefined length range. Within the predefined range, the start and end frames may be selected as the frames that best match the idle frame (e.g., have the lowest distance of the facial landmarks to the corresponding locations in the idle frame). Start and end frames for an idle segment around the idle frame may also be identified. The start and end frames may similarly be detected as frames that strongly match the idle frame. Selecting start and end frames that closely match the idle frame ensures that natural looking transitions between segments can be achieved in the reactive profile pictures because the transitions will occur at similar-looking frames.

In an embodiment, a range of frames at the beginning and end of each segment may be also be identified as overlapping frames. When displaying the reactive profile picture, ending overlapping frames of one video segment may be blended with starting overlapping frames of another video segment to produce a smooth transition between segments as will be described in further detail below.

The videos are then segmented 416 into the emotion segments between the respective start and end frames and the segments are stored to the emotion segment store 320.

### Generating Reactive Profile Pictures

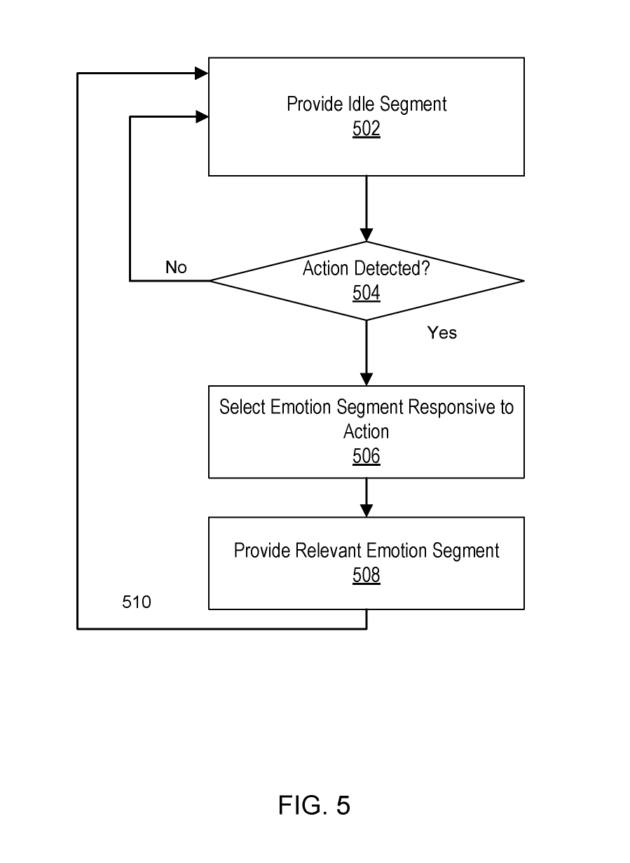

FIG. 5 illustrates an embodiment of a process for generating a reactive profile picture for display in response to an action. The reactive profile picture display module 340 initially provides 502 an idle segment of a reactive profile picture of a target user to a client device of a viewing user viewing content in the online system 140 associated with the target user. The content may comprise, for example, a profile page of the target user, a post by the target user, a comment from the target user, a direct or group message form the target user, or any other content associated with the target user that is displayed together with a reactive profile picture depicting the target user. The idle segment may comprise a segment depicting the target user with a neutral expression. In one embodiment, the idle segment may be continuously looped to give the appearance of a real-time video stream of the target user. To avoid an abrupt cut between the last frame of the idle segment and the first frame of the idle segment when looping, a set of overlapping frames at the end of the idle segment may be blended with a set of overlapping frames at the beginning of the idle segment to produce a smooth transition.

The emotion segment selection module 330 determines 504 if an action is detected on a client device 110 of a viewing user that is viewing content on the online system 140 that is displayed together with a reactive profile picture of a target user. The action may comprise, for example, a selection of an emoticon on the client device 110 of the viewing user associated with the content relating to the target user, detection of a sentiment of a comment posted by the viewing user relating to the content of the target user, detection of an emotion expressed by the viewing user in a video of the viewing user captured while the viewing user views the content of the target user, detection of an emotion expressed by the viewing user in an audio clip captured while the viewing user views the content of the target user, detecting a gesture (e.g., scrolling in a newsfeed or turning the viewing user's head in a virtual reality environment) or any other interaction of the viewing user with the content of the target user displayed with the reactive profile picture.

As long as no relevant action is detected 504, the idle segment may continue to loop. If an action is detected, the segment selection module 330 selects 506 a segment in response to the detected action. The selected segment depicts the target user with an expression relevant to the particular detected action. For example, the selected segment may depict an expression of the target user that mimics or reacts to a sentiment expressed by the viewing user. For example, if the viewing user selects a “like” emoticon, a segment associated with happiness or approval may be selected. If the viewing user selects an “anger” emoticon, a segment associated with an anger expression may be selected. Similarly, if a video of the viewing user detects the viewing user laughing, a segment of the target user laughing may be selected.

The selected emotion segment is then provided 508 to the client device 110 of the viewing user for display in the reactive profile picture. For example, a number of overlapping frames at the start of the selected segment may be blended with overlapping frames at the end of the idle segment in order to give the appearance of a natural transition from the neutral expression to the selected expression. After providing the selected segment, the reactive profile picture may then similarly be transitioned 510 back to the idle segment. For example, overlapping frames at the end of the selected segment may be blended with the overlapping frames at the start of the idle segment to naturally transition the reactive profile picture back to the neutral expression. The process may then start over with the idle segment continuing to loop.

In one embodiment, a blending algorithm may be applied to blend ending overlapping frames in the segment being transitioned from with beginning overlapping frames in the segment being transitioned to. The same blending process may be used when transitioning between segments or when looping a segment (e.g., the idle segment). For example, in an embodiment, a first sequence of aligning and warping transformations is determined that aligns the overall images in the ending set overlapping frames of the segment (being transitioned from) and warps the images in the ending set of overlapping frames to align the locations of the facial landmarks in the ending set of overlapping frames to their locations in corresponding frames of the beginning set overlapping frames (being transitioned to). For example, in a segment of N frames with M overlapping frames on each end, a first transformation T₁ is determined to align and warp frame 1 to frame N−M+1, a second transformation T₂ is determined to align and warp frame 2 to frame N−M+2, etc. The transformations are then weighted (e.g., with increasing weights from 0 to 1 over the duration of the set of overlapping frames) to generate a sequence of weighted transformations. The sequence of weighted transformations are applied to the ending set of overlapping frames being transitioned from such that no warp is applied to the first frame in the ending set of overlapping frames and the full warp is applied to the last frame in the ending set of overlapping frames. Over the duration of the set of overlapping frames being transitioned from, the amount of warp increases (e.g., linearly or non-linearly). Similarly, a second sequence of aligning and warping transformations is determined that aligns the overall images in the beginning set of overlapping frames (being transitioned to) and warps the images to align the locations of the facial landmarks in the beginning set of overlapping frames to their locations in corresponding frames of the ending set of overlapping frames (being transitioned from). For example, the second sequence of transformations may be an inverse of the first sequence of transformations. The second set of transformations are also weighted (e.g., with decreasing weights from 1 to 0 over the duration of the segment) and applied to the beginning set of overlapping frames such that a full warp is applied to the first frame in the beginning set of overlapping frames and no warp is applied to the last frame in the beginning set of overlapping frames. Over the duration of the set of overlapping frames being transitioned to, the amount of warp decreases (e.g., linearly or non-linearly). The warped sets of overlapping frames are then blended together. For example, a weighted blend may be applied in which weights decreasing from 1 to 0 are applied to the ending set of overlapping frame being transitioned from and weights increasing from 0 to 1 are applied to the beginning set of overlapping frames being transitioned to.

Using the above-described process, the reactive profile picture appears to react to the action by the viewing user in a manner similar to a typical human-to-human interaction. This creates a more intimate and realistic experience for the viewing user.

Reactive Profile Picture from Single Input Image

In an alternative embodiment, a reactive profile picture for a target user may be generated from a single input image of the target user instead of from a video input. In this embodiment, expressions of the target user are synthesized by animating the input image. Beneficially, in this embodiment, the target user does not necessarily need to provide an input video depicting the various expressions. Thus, a reactive profile picture feature could be introduced in an online system 140 based on existing profile images of users without the users having to provide any new input video to activate the feature. For this feature, the target user may opt in to the feature to enable the reactive profile picture to be generated from a stored profile image provided by the target user such that the feature is not available without the target user's consent.

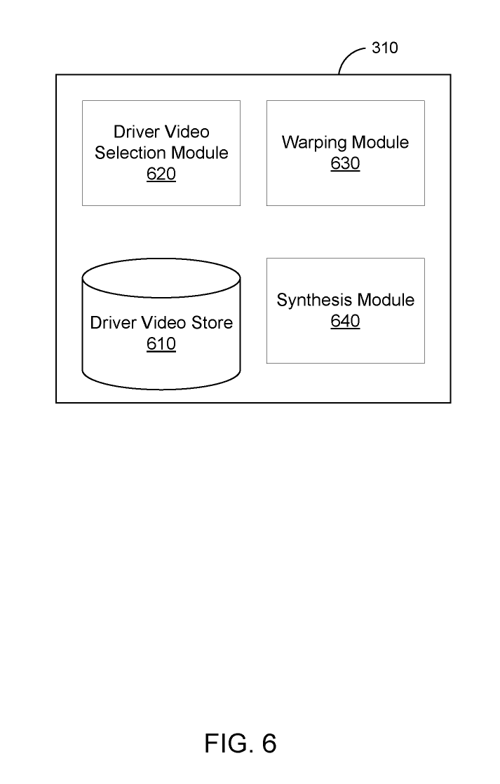

FIG. 6 illustrates an example embodiment of a segment acquisition module 310 that may be used to generate emotion segments from a single input image of a target user. A driver video store 610 stores a library of driver videos each depicting a different subject performing a sequence of expressions relating to different reactions or emotions. The driver videos may be similar to the input video described above. The online system 140 may enable the users depicted in the driver video to opt in to being included in the library such that the user provides consent to using the driver videos to drive reactive profile pictures of other users as described below.

The driver video selection module 620 selects a driver video that best matches the input image. For example, in one embodiment, a similarity metric may be determined between the input mage of the target user and a reference frame (e.g., an idle frame) in each driver video. The driver video selection module 620 may then choose the driver video in which the subject has the best similarity to the target user. In an embodiment, the similarity metric may be determined based on distances between the facial landmark in the input image and the driver subject reference images (e.g., using an L2-norm distance metric). In another embodiment, various metadata may be used to determine similarity. For example, metadata indicating the race, gender, age, or other information may be compared to determine a driver subject that is most likely to have similar appearance to the target user.

The warping module 630 applies a sequence of warps to the input image to generate a sequence of output images. Here, each output image corresponds to one of the frames of the driver video and the warp applied for a given frame is based on a transformation that transforms locations of the facial landmarks in the idle frame of the driver video to the given frame of the driver video. Thus, each frame of the output video warps the input image to match the movement of the facial landmarks in the driver video. In this way, the facial expressions in the output video (based on the input image) mimic the expressions of the subject in the driver video.

Simply warping the input image according to the transformations described above may result in various artifacts in the output video. For example, facial features such as the eye lids, teeth, and tongue may be occluded in the input image. Thus, for example, if the subject of the driver video opens her mouth, the corresponding frames generated from warping the input image will depict stretched portions of the lips in the mouth region because the inside of the mouth is occluded and does not exist in the input image. To reduce these artifacts, a synthesis module 640 may synthesize the potentially occluded facial features of the input image when generating the output frames. For example, in one embodiment, the eyes and interior portion of the mouth (e.g., inside the lips) may be transferred from the driver image onto the input image at each warped frame. Thus, the output video may actually depict the driver subject's eyes and interior of the mouth in place of those facial features of the subject of the input image. In an embodiment, the synthesis module 640 may apply various color matching and blending algorithms to make the synthesized facial features appear natural.

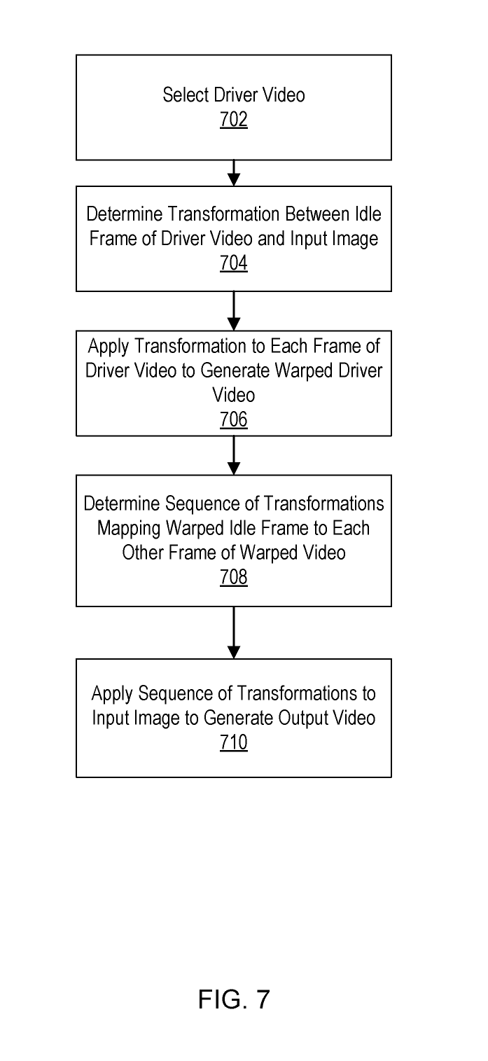

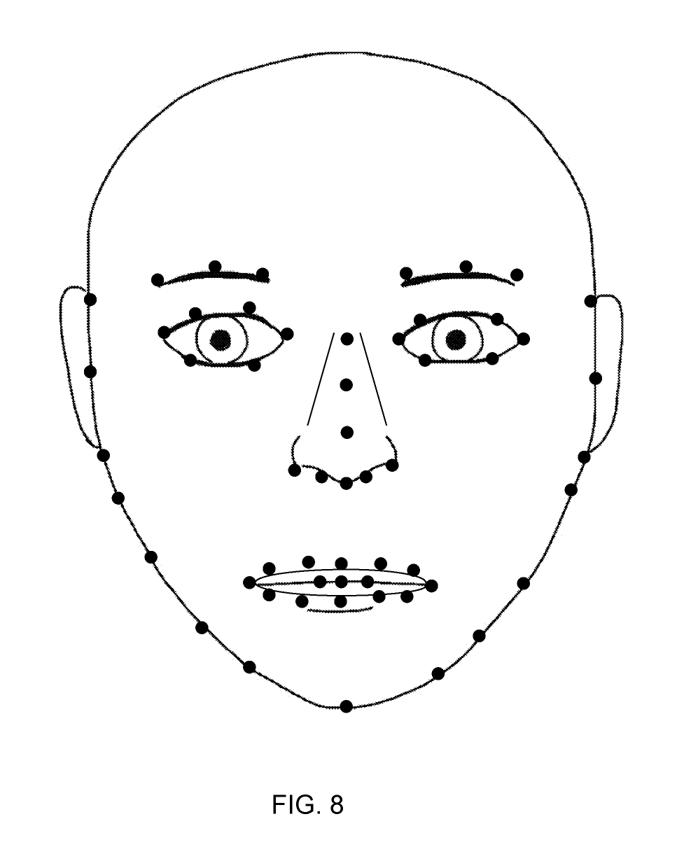

FIG. 7 illustrates an embodiment of a process for generating video segments for a reactive profile picture from a single input image. A driver video is first selected 702 that will be used to generate the output video from a library of available driver videos. For example, the driver video may be selected that depicts a subject most similar to the subject of the input image based on a facial landmark analysis, descriptive metadata, or a combination of factors.

A transformation is then determined 704 between the idle frame of the driver video and the input image. For example, the transformation may represent a mapping of the locations of the facial landmarks in the idle frame of the driver video to the locations of corresponding facial landmarks in the input image. The transformation is then applied 706 to each frame of the driver video. This transformation warps each frame of the driver video to generate a warped driver video in which the facial landmarks are re-positioned to better correspond to the subject of the input image.

A sequence of transformations is then determined 708 that represents, for each frame of the warped driver video, a transformation that maps the warped idle frame of the driver video to each other frame of the warped driver video. These transformations indicate how the facial feature points in the warped driver video change from the neutral expression in the idle frame to each of the other frames in the warped driver video while the driver subject expresses the different individual expressions. The sequence of transformations are then separately applied 710 to the input image to generate a sequence of output frames. For example, the first transformation in the sequence is applied to the input image to generate the first frame of the output video, the second transformation in the sequence is applied to the input image to generate the second frame of the output video, and so on. The output frames result in an output video in which the input image is warped to mimic the expressions made by the driver subject in the driver video.

In one embodiment, to avoid common artifacts in the output video, facial features that are occluded in the input image may be synthesized. For example, parts of the driver subject's face in the warped drive video such as they eyes and/or inside of the mouth may be directly copied to the output video.

The obtained video may then be segmented into the different expression segments and applied to generate the reactive profile pictures using the techniques described above.

In an alternative embodiment, instead of segmenting the output video after it is generated from the input image and a driver video, a plurality of different emotion segments may instead be separately generated from different pre-segmented segments of the driver video. Thus, in this embodiment, emotion segments are directly generated from segments of the driver video.

### Additional Embodiments

In other implementations applicable to any of the embodiments described above, additional features may also be detected that do not necessarily correspond to facial features. For example, a motion tracking algorithm may detect and track parts of the upper torso, hair, or other non-facial features. These additional features may be used to compute the similarity metrics and transformations between frames together with the facial landmarks described above. In an embodiment, the non-facial features may be weighted differently than facial features when computing the similarity metrics or transformations.

In other alternative implementations, image frames may be pre-processed to align the subject's head or portions thereof to an idle image or other reference in addition to performed the processing described above. In further embodiments, color matching techniques may be applied to compensate for color differences between image frames.

### Conclusion

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

1. A method comprising:
storing to a storage medium in association with a profile of a target user, a plurality of video segments depicting a portrait of a target user, wherein each of the plurality of video segments is associated with a different emotion and depicts the target user expressing the corresponding emotion, the plurality of video segments including an idle segment depicting the target user in a neutral expression;
providing to a client device of a viewing user, a presentation of the idle segment together with content associated with the target user;
detecting an interaction of the viewing user on the client device with the content associated with the target user;
analyzing, by a processor, the interaction to determine a sentiment associated with the interaction;
selecting, based on the sentiment, a reactive video segment from the plurality of video segments, the reactive video segment associated with an emotion corresponding to the sentiment of the interaction; and
presenting the reactive video segment to the client device.

2. The method of claim 1, wherein presenting the reactive video segment comprises:
blending a sequence of starting overlapping frames associated with the reactive video segment with a sequence of ending overlapping frames associated with the idle segment to generate a sequence of transition frames; and
presenting the transition frames to transition from the idle segment to the reactive video segment.

3. The method of claim 2, wherein blending the sequence of starting overlapping frames associated with the reactive video segment with a sequence of ending overlapping frames associated with the idle segment comprises:
determining a sequence of transformations to warp the sequence of ending overlapping frames to align locations of facial landmarks in the sequence of ending overlapping frames to locations of facial landmarks in the sequence of starting overlapping frames;
weighting the sequence of transformations with increasing weights over a duration of the sequence of ending overlapping frames and the sequence of starting overlapping frames to generate a weighted sequence of transformations;
applying the weighted sequence of transformations to the ending overlapping frames to generate the sequence of transition frames.

4. The method of claim 1, further comprising:
blending a starting set of overlapping frames associated with the idle segment with a set of ending overlapping frames associated with the reactive video segment to generate a set of ending transition frames; and
presenting the ending transition frames to transition from the reactive video segment back to the idle video segment.

5. The method of claim 1, wherein detecting the interaction comprises detecting a selection of an emoticon by the viewing user associated with the content associated with the target user, and wherein analyzing the interaction comprises:
identifying a predefined association between the emoticon and the sentiment.

6. The method of claim 1, wherein detecting the interaction comprises detecting a written post by the viewing user associated with the content associated with the target user, and wherein analyzing the interaction comprises:
performing a sentiment analysis of text of the written post; and
determining the sentiment from the sentiment analysis.

7. The method of claim 1, wherein detecting the interaction comprises capturing a video of the viewing user while viewing the content associated with the target user, and wherein analyzing the interaction comprises:
performing a facial analysis to detect an expression of the viewing user; and
determining the sentiment from the detected expression.

8. A non-transitory computer-readable storage medium storing instructions executable by a processor, the instructions when executed causing the processor to perform steps including:
storing in association with a profile of a target user, a plurality of video segments depicting a portrait of a target user, wherein each of the plurality of video segments is associated with a different emotion and depicts the target user expressing the corresponding emotion, the plurality of video segments including an idle segment depicting the target user in a neutral expression;
providing to a client device of a viewing user, a presentation of the idle segment together with content associated with the target user;
detecting an interaction of the viewing user on the client device with the content associated with the target user;
analyzing the interaction to determine a sentiment associated with the interaction;
selecting, based on the sentiment, a reactive video segment from the plurality of video segments, the reactive video segment associated with an emotion corresponding to the sentiment of the interaction; and
presenting the reactive video segment to the client device.

9. The non-transitory computer-readable storage medium of claim 8, wherein presenting the reactive video segment comprises:
blending a sequence of starting overlapping frames associated with the reactive video segment with a sequence of ending overlapping frames associated with the idle segment to generate a sequence of transition frames; and
presenting the transition frames to transition from the idle segment to the reactive video segment.

10. The non-transitory computer-readable storage medium of claim 9, wherein blending the sequence of starting overlapping frames associated with the reactive video segment with a sequence of ending overlapping frames associated with the idle segment comprises:
determining a sequence of transformations to warp the sequence of ending overlapping frames to align locations of facial landmarks in the sequence of ending overlapping frames to locations of facial landmarks in the sequence of starting overlapping frames;
weighting the sequence of transformations with increasing weights over a duration of the sequence of ending overlapping frames and the sequence of starting overlapping frames to generate a weighted sequence of transformations;
applying the weighted sequence of transformations to the ending overlapping frames to generate the sequence of transition frames.

11. The non-transitory computer-readable storage medium of claim 8, wherein the instructions when executed by the processor further cause the processor to perform steps including:
blending a starting set of overlapping frames associated with the idle segment with a set of ending overlapping frames associated with the reactive video segment to generate a set of ending transition frames; and
presenting the ending transition frames to transition from the reactive video segment back to the idle video segment.

12. The non-transitory computer-readable storage medium of claim 8, wherein detecting the interaction comprises detecting a selection of an emoticon by the viewing user associated with the content associated with the target user, and wherein analyzing the interaction comprises:
identifying a predefined association between the emoticon and the sentiment.

13. The non-transitory computer-readable storage medium of claim 8, wherein detecting the interaction comprises detecting a written post by the viewing user associated with the content associated with the target user, and wherein analyzing the interaction comprises:
performing a sentiment analysis of text of the written post; and
determining the sentiment from the sentiment analysis.

14. The non-transitory computer-readable storage medium of claim 8, wherein detecting the interaction comprises capturing a video of the viewing user while viewing the content associated with the target user, and wherein analyzing the interaction comprises:
performing a facial analysis to detect an expression of the viewing user; and
determining the sentiment from the detected expression.

15. A computer system comprising:
a processor; and
a non-transitory computer-readable storage medium storing instructions executable by the processor, the instructions when executed causing the processor to perform steps including:
storing in association with a profile of a target user, a plurality of video segments depicting a portrait of a target user, wherein each of the plurality of video segments is associated with a different emotion and depicts the target user expressing the corresponding emotion, the plurality of video segments including an idle segment depicting the target user in a neutral expression;
providing to a client device of a viewing user, a presentation of the idle segment together with content associated with the target user;
detecting an interaction of the viewing user on the client device with the content associated with the target user;
analyzing the interaction to determine a sentiment associated with the interaction;
selecting, based on the sentiment, a reactive video segment from the plurality of video segments, the reactive video segment associated with an emotion corresponding to the sentiment of the interaction; and
presenting the reactive video segment to the client device.

16. The computer system of claim 15, wherein presenting the reactive video segment comprises:
blending a sequence of starting overlapping frames associated with the reactive video segment with a sequence of ending overlapping frames associated with the idle segment to generate a sequence of transition frames; and
presenting the transition frames to transition from the idle segment to the reactive video segment.

17. The computer system of claim 16, wherein blending the sequence of starting overlapping frames associated with the reactive video segment with a sequence of ending overlapping frames associated with the idle segment comprises:
determining a sequence of transformations to warp the sequence of ending overlapping frames to align locations of facial landmarks in the sequence of ending overlapping frames to locations of facial landmarks in the sequence of starting overlapping frames;
weighting the sequence of transformations with increasing weights over a duration of the sequence of ending overlapping frames and the sequence of starting overlapping frames to generate a weighted sequence of transformations;
applying the weighted sequence of transformations to the ending overlapping frames to generate the sequence of transition frames.

18. The computer system of claim 15, wherein the instructions when executed by the processor further cause the processor to perform steps including:
blending a starting set of overlapping frames associated with the idle segment with a set of ending overlapping frames associated with the reactive video segment to generate a set of ending transition frames; and
presenting the ending transition frames to transition from the reactive video segment back to the idle video segment.

19. The computer system of claim 15, wherein detecting the interaction comprises detecting a selection of an emoticon by the viewing user associated with the content associated with the target user, and wherein analyzing the interaction comprises:
identifying a predefined association between the emoticon and the sentiment.

20. The computer system of claim 15, wherein detecting the interaction comprises detecting a written post by the viewing user associated with the content associated with the target user, and wherein analyzing the interaction comprises:
performing a sentiment analysis of text of the written post; and
determining the sentiment from the sentiment analysis.
